(19) United States
(12) Patent Application Publication
(10) Pub. No.: US 2005/0166866 A1
(43) Pub. Date: Aug. 4, 2005

(54) Pet toy with loop ends

(76) Inventor: Robert Dobihal, Minnetrista, MN (US)

Correspondence Address: Fulbright & Jaworski LLP - John F. Klos, Esq., Suite 2100, 80 South Eighth Street, Minneapolis, MN, 55102-2112, US

(21) Appl. No.: 11/027,607

(22) Filed: Dec. 28, 2004

Related U.S. Application Data
(63) Continuation-in-part of application No. 10/456,462, filed on Jun. 5, 2003, now abandoned.
(60) Provisional application No. 60/386,656, filed on Jun. 5, 2002.

(51) Int. Cl. A01K 29/00

(52) U.S. Cl. 119/709

(57) ABSTRACT

A pet toy in animal form having a body and appendages extending from the body and defining free ends from which a flexible cord of material defines a plurality of loop portions extending from the free ends. The pet toy may be defined by a plurality of fabric elements which are secured together to capture at least a portion of the flexible cord. The loop portions may be smaller in size than the free ends of the associated elongated appendages.

### RELATED APPLICATIONS

This application is a continuation-in-part of U.S. Ser. No. 10/456,462, filed Jun. 5, 2003, which claimed the benefit of U.S. Provisional Application No. 60/386,656 filed on Jun. 5, 2002, and each application is hereby incorporated by reference in its entirety.

### FIELD OF THE INVENTION

The present invention relates generally to a pet toy. In particular, the present invention relates to a durable toy in animal form which is adapted to amuse animals such as a dog or cat.

### BACKGROUND OF THE INVENTION

Many animals, such as dogs and cats enjoy throwable play things. Prior animal play toys have been designed to occupy the animals in some sort of activity, such as chewing, gnawing, and pulling. Since a pet toy is generally treated roughly and is typically carried in the animal's mouth, it is important to provide a play toy for animals which is durable and safe. To minimize choking hazards, it is especially important that the pet toy not break apart in the animal's mouth. As such, there is a need in the art for a novel pet toy wherein the appendages of the pet toy do not constitute a potential choking hazard to the pet.

### SUMMARY OF THE INVENTION

The present invention is directed to a pet toy having a body in animal form with a plurality of elongated appendages extending away from the body. Each of the plurality of appendages extends in a different direction of elongation and each of the appendages defines a free end. A flexible cord is partially disposed within the body and defines at least separated first and second loop portions extending out of the free ends of a pair of appendages. Preferably, the loop portions extend in the direction of elongation of associated appendages.

In one embodiment, the pet toy is comprised of a multipart plush fabric body and a flexible cord. The body is made of at least two parts sewn to each other along peripheral edges of the parts. The body may contain filling materials such as pellets or other materials to add bulk to the body. Noisemakers, such as squeakers, air pillows, etc. may also be disposed within the body.

In one embodiment, the flexible cord forms a loop disposed within and attached to the body. The loop forms a plurality of loop portions which extend from the body. Each loop portion extends from each end such a distance that loop will allow it to be grasped by an animal.

To pique the interest of the animal, many pet toys are designed to imitate common creatures. Many are often designed to have a body with appendages extending from the body. Aside from making the toy appear more realistic to the animal, the appendages also offer an easy grasping point.

It is an object of the invention to provide an article that will entertain an animal. It is a further object of the invention to provide an article for entertaining an animal that is very attractive to the animal.

### DESCRIPTION OF THE DRAWINGS

Preferred embodiments of the invention will be described in detail hereinafter with reference to the accompanying drawings, in which like reference numerals refer to like elements throughout.

FIG. 1 is a perspective view of a pet toy according to the present invention.

FIG. 2 is a top view of the toy in a starfish profile shape with a top portion of the toy removed to disclose the cord disposed therein, with loop ends formed from a cord in a particular configuration.

FIG. 3 is a side elevational view of the toy of FIG. 2.

FIG. 4 is a top view of another embodiment of the toy in a starfish form.

FIG. 5 is an alternative embodiment of the toy of FIG. 2.

### DETAILED DESCRIPTION OF THE INVENTION

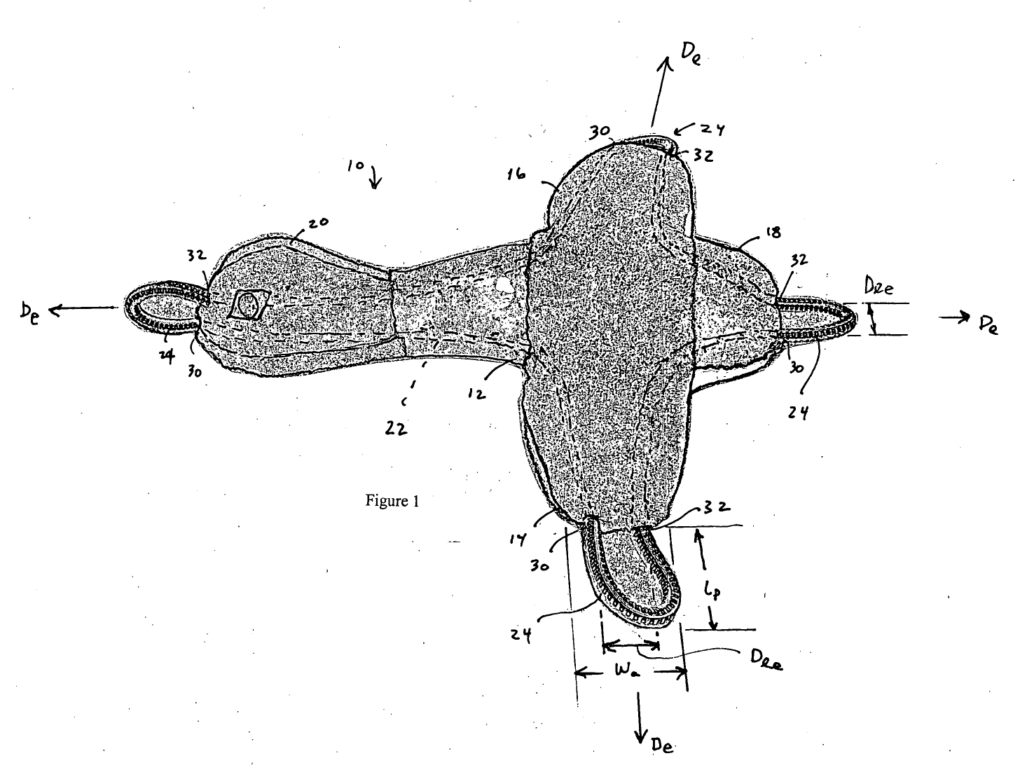

Referring to FIG. 1, in one embodiment the pet toy 10 according to the present invention is provided in bird-like form with a body 12 and appendages 14, 16, 18, 20. Pet toy 10 is preferably formed of multiple pieces of sewn plush fabric material. A flexible cord 22 extends within body 12 and exits body 12 at the free ends of the appendages 14, 16, 18, 20 where the cord 22 defines loop portions 24. The loop portions 24 have a length, Lₚ, of between 0.75 inch and 3.5 inches. More preferably, the length of loop portions 24 is between 1 and 2 inches. The free ends of the appendages 14, 16, 18, 20 define a width, Wₐ. In preferred embodiments of the invention, the distance between the loop ends 30, 32, defined as Dₗₑ, (measured at the loop/appendage intersection) is substantially less than the width, Wₐ, of the associated appendage. The loop portions 24 preferably extend out of the free ends of the appendages in the direction of elongation of the appendages. In the example of FIG. 1, the directions of elongation of the appendages are designated Dₑ.

In the embodiment of FIG. 1, the loop portions 24 of wing appendages 14, 16 and tail appendage 18 are generally co-planar, while the loop portion 24 of head appendage 20 is generally perpendicular to a plane containing the loop portions 24 of the other appendages 14, 16, 18. Preferably the flexible cord 22 is a single piece of material, such as a fiber-coated elastic material or rope.

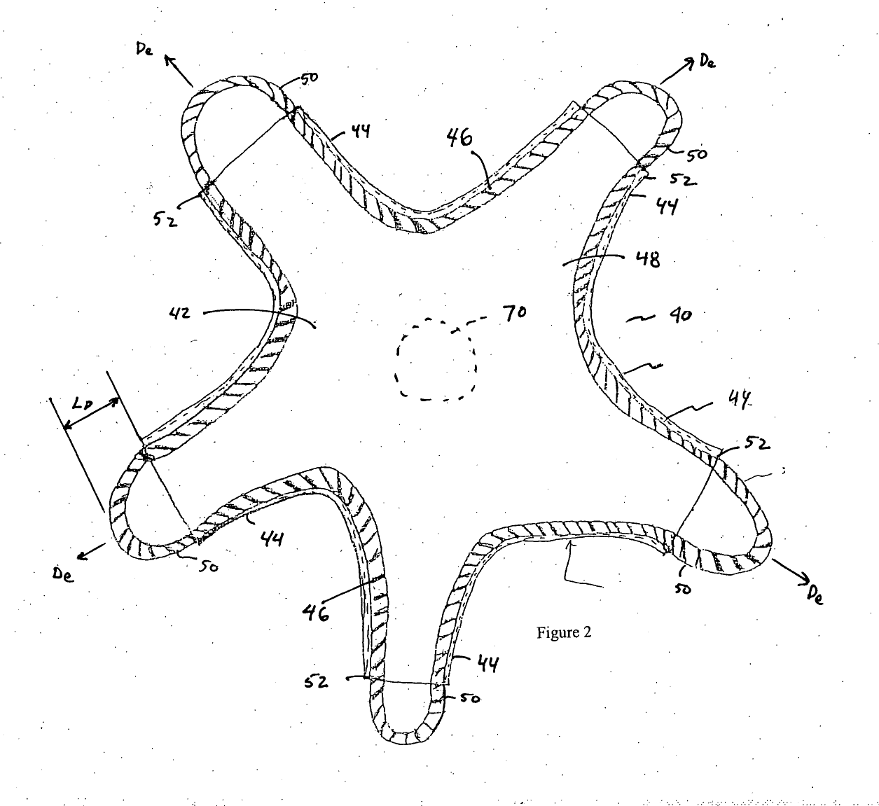

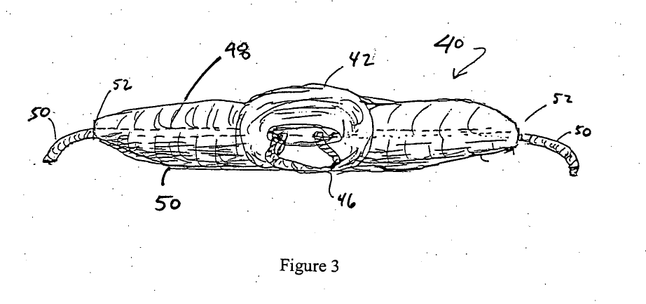

Referring to FIGS. 2 through 4, in another embodiment the pet toy 40 is provided in a starfish form. The toy 40 comprises of a body 42 defining a plurality of appendages 44 and a flexible cord 46 partially contained within body 42. The body 42 is formed of any of a variety of tough materials depending upon the characteristics that are desired, including plastic, fleece, cloth, nylon to name a few. In one embodiment, the body 40 is made of two overlaying pieces 48, 50 which are sewn together along peripheral edges of the pieces 48, 50. Alternative securement approaches to sewing would be readily appreciated by those skilled in the relevant arts. The body 42 may contain filling materials such as pellets or other materials to add bulk to the body. The body 42 may also contain a noisemaking article, such as a rattle, squeaker 70, air pillows, etc.

In one embodiment, the flexible cord 46 forms a loop which is mostly disposed within the body 42. Loop portions 50 extend from free ends 52 of toy 40. Each loop portion 50 is secured to an associated free end 52. Alternatively, in one embodiment, the loop portions 50 are allowed to generally freely slide inwardly and outwardly from within the body.

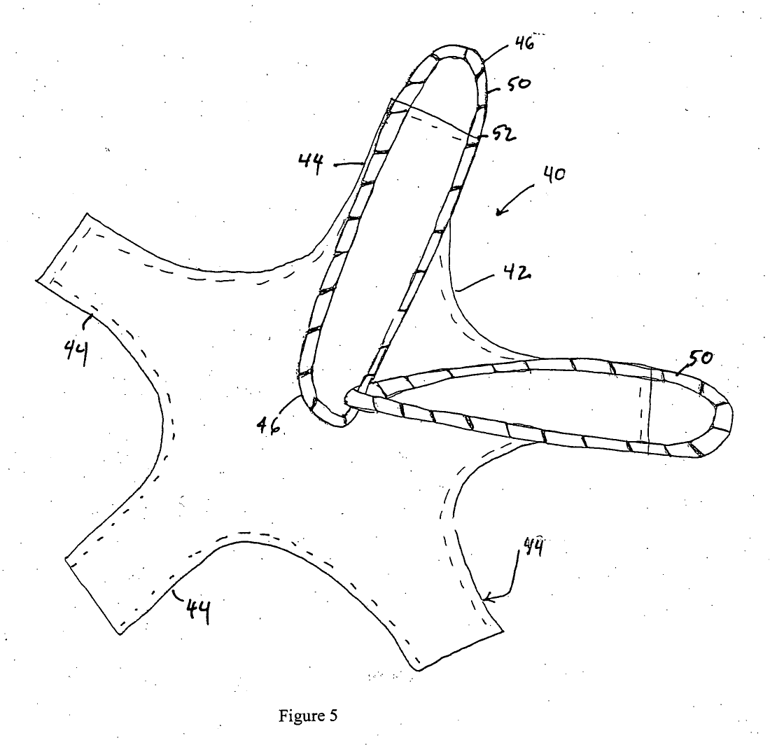

Flexible cord 46 may be a rope, string, or other elongated flexible element. Cord 46 may be manufactured from natural or synthetic products or a combination thereof. Preferably a single cord element is utilized to practice the invention. Alternatively, a plurality of cord elements 46 may be utilized. It is also contemplated (as shown in FIG. 5) that a plurality of interconnected loops be formed from multiple interconnected cord elements 46, with each loop having a loop portion 50 extending from the body.

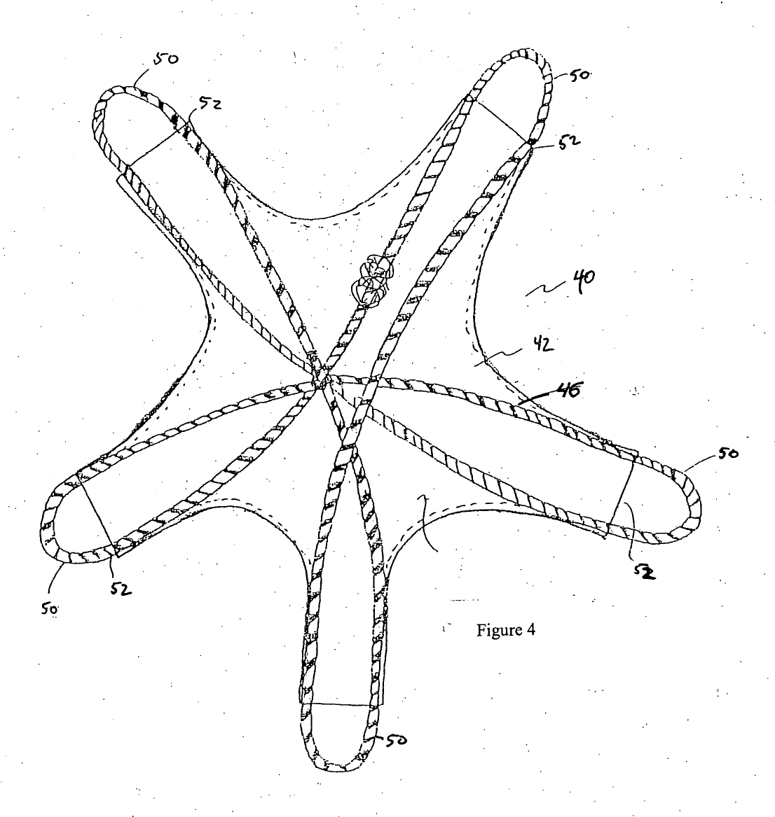

Referring to FIG. 4, in another embodiment of the starfish form toy 40 an alternative routing attachment of cord 46 within body 42 is illustrated. In this configuration, the cord 46 is generally provided along the peripheral edge of pieces 48, 50.

Still other representative embodiments and advantages of the present invention and methods of construction of the same will become readily apparent to those skilled in the art from the following detailed description, wherein only the preferred embodiments are shown and described, simply by way of illustration of the best mode contemplated for carrying out the invention. As will be realized, the invention is capable of other and different embodiments and methods of construction, and its several details are capable of modification or adaptation in various respects all without departing from the invention as disclosed and claimed. Accordingly, the appended drawings and description contained herein, as well as the descriptions and drawings contained in the applications and associated documents to which the benefit of priority has been claimed and which are incorporated herein by reference as though fully set forth, are to be regarded as illustrative in nature and not as restrictive or limiting.

1. A pet toy comprising:
a body in animal form and a plurality of elongated appendages related in context to the animal form of the body and extending away from the body, each of the plurality of elongated appendages extending in a different direction of elongation, and each of the plurality of elongated appendages defining a free end; and
a flexible cord at least partially disposed within the body and the plurality of elongated appendages, said flexible cord defining separated first and second loop portions extending out of free ends of an associated pair of appendages, wherein each of the first and second loop portions extend from the free end in a direction of elongation of the associated appendage.

2. The pet toy of claim 1 wherein the body is defined by a plurality of fabric elements.

3. The pet toy of claim 2 wherein the plurality of fabric elements are sewn together.

4. The pet toy of claim 1 wherein each free end of an elongated appendage defines a width, Wₐ, and wherein a distance between loop ends, Dₗₑ, is substantially less than Wₐ.

5. The pet toy of claim 1 wherein the loop portions have a length, Lₚ, of between 0.75 inch and 3.5 inches.

6. The pet toy of claim 5 wherein the length, Lₚ, is between 1 inch and 2 inches.

7. The pet toy of claim 1 further comprising a squeaker element.

8. A method of making a pet toy comprising:
forming an animal body and a plurality of elongated appendages, each of said plurality of elongated appendages defining a free end, and each of said plurality of elongated appendages extending in a direction of elongation;
disposing a flexible cord within the animal body and the plurality of appendages so that separated first and second loop portions extend out of the free ends of separate appendages of the animal body, said loop portions extending in the directions of elongation of associated appendages; and
securing the flexible cord to the animal body by seaming the fabric together around a peripheral seam of the animal body.

9. The method of claim 8 wherein the first and second loop portions are substantially smaller than the animal body.

10. The method of claim 8 wherein each free end of an elongated appendage defines a width, Wₐ, and wherein a distance between loop ends, Dₗₑ, is substantially less than Wₐ.

11. The method of claim 8 wherein the loop portions have a length, Lₚ, of between 0.75 inch and 3.5 inches.

12. The method of claim 11 wherein the length, Lₚ, is between 1 inch and 2 inches.

13. A pet toy comprising:
a body and a plurality of appendages extending away from the body, each of the plurality of elongated appendages extending in a different direction of elongation, and each of the plurality of elongated appendages defining a free end; and
a plurality of closed loops disposed within the body, with each loop being interconnected to another loop, and wherein each closed loop has a loop portion extending from a free end of an associated appendage of the body in a direction of appendage elongation.

14. The pet toy of claim 13 wherein the body is defined by a plurality of fabric elements.

15. The pet toy of claim 14 wherein the plurality of fabric elements are sewn together.

16. The pet toy of claim 13 wherein each free end of an elongated appendage defines a width, Wₐ, and wherein a distance between loop ends, Dₗₑ, is substantially less than Wₐ.

17. The pet toy of claim 13 wherein the loop portions have a length, Lₚ, of between 0.75 inch and 3.5 inches.

18. The pet toy of claim 17 wherein the length, Lₚ, is between 1 inch and 2 inches.

19. The pet toy of claim 13 further comprising a squeaker element.

20. The pet toy of claim 13 wherein the body and appendages define a bird-like form and wherein the loop ends of wing appendages are generally coplanar and the loop ends associated with a head appendage is generally perpendicular to a plane containing the loop ends of the wing appendages.
